(19) United States
(12) Patent Application Publication
(10) Pub. No.: US 2023/0420747 A1
(43) Pub. Date: Dec. 28, 2023

(54) SYSTEMS FOR PUMP-FREE ZINC BROMIDE BATTERIES

(71) Applicant: The Trustees of Columbia University in the City of New York, New York, NY (US)

(72) Inventors: Robert Mohr, New York, NY (US); Daniel Steingart, New York, NY (US); Alan West, Tenafly, NJ (US); Mateo Williams, New York, NY (US)

(73) Assignee: The Trustees of Columbia University in the City of New York, New York, NY (US)

(21) Appl. No.: 18/036,708

(22) PCT Filed: Nov. 12, 2021
(86) PCT No.: PCT/US2021/059057

§ 371 Date: May 12, 2023

Related U.S. Application Data
(60) Provisional application No. 63/112,708, filed on Nov. 12, 2020.

(51) Int. Cl. H01M 10/36; H01M 12/08; H01M 8/18; H01M 8/0258

(52) U.S. Cl. CPC H01M 10/365; H01M 12/085; H01M 8/188; H01M 8/0258; H01M 2008/1095

(57) ABSTRACT

An energy storage system comprises a plurality of electrochemical cells. The electrochemical cells include a pair of electrodes including an anode and a cathode. An electrolyte in communication with the pair of electrodes. A flow shaping baffle is situated between the pair of electrodes. The flow shaping baffle includes a plurality of channels extending from a first end proximate the cathode to a second end proximate the anode along an axis substantially perpendicular to the electrodes. The first end has a first diameter and the second end has a second diameter. The first diameter is greater than the second diameter. The disclosed energy storage system does not require expensive pumps or ion exchange membranes and can operate efficiently over a long service life.

### CROSS REFERENCE TO RELATED APPLICATION(S)

This application claims the benefit of U.S. Provisional Application No. 63/112,708, filed Nov. 12, 2020, which is incorporated by reference as if disclosed herein in its entirety.

### STATEMENT REGARDING FEDERALLY SPONSORED RESEARCH AND DEVELOPMENT

This invention was made with U.S. Government support under DE-AR0000990 awarded by the Department of Energy. The United States Government has certain rights in the invention.

### BACKGROUND

In an electrochemical energy storage system where one or more soluble species are generated during operation, a significant issue is “crossover,” where one or more products formed at one electrode reaches the opposite electrode leading to a detrimental side reaction. These electrochemical energy storage systems are typically utilized in a flow battery design where an expensive ion exchange membrane is necessary to prevent the crossover of the active species and a pump is required to actively circulate an electrolyte to ensure full utilization of a reactant. These ion exchange membranes and pumps are expensive cost drivers in such flow batteries.

### SUMMARY

Some embodiments of the present disclosure are directed to a flow battery and flow battery systems including a plurality of electrochemical cells in a horizontal cell format that enable high performance and high energy density with or without active pumping of the electrolyte and/or an ion exchange membrane. This innovative design approach takes advantage of the natural flow that arises due to density gradients formed as reactions take place at the electrode surface(s). In some embodiments, a separator and a baffle are included to shape this natural flow in order to prevent crossover reactions and to drive reactants towards the proper electrode for the reaction. Although ion exchange membranes could result in improved performance and reduced crossover, they are not necessary for high efficiency of the disclosed design. This design is applicable to electrochemical couples having soluble species and where there is a density change between reactant and product. By way of non-limiting example, the battery cell design of the present disclosure could be used for, but are not limited to the following electrochemical reactions:

Bromine Rection:

Br₂+2e⁻→2Br⁻

Iron Chloride Reaction:

2FeCl₃+2e⁻→2FeCl₂+2Cl⁻

Polysulfide Reaction:

S₂²⁻+2e−→2S²⁻

Vanadium Rection:

V³⁺+e⁻→V²⁺

Lead/Lead Sulfate, Lead Oxide/Lead Sulfate Reaction

An electrochemical cell is a device capable of either generating electrical energy from chemical reactions or using electrical energy to cause chemical reactions. The terms electrochemical cell and battery, including singular and plural are used interchangeably herein. A battery generally consists of one or more electrochemical cells, connected in parallel, series or series-and-parallel pattern.

In one non-limiting embodiment of the present disclosure an energy storage system has a plurality of electrochemical cells. The electrochemical cells including a pair of electrodes including an anode and a cathode. An electrolyte is in communication with the pair of electrodes. A flow shaping baffle is situated between the pair of electrodes. The baffle includes a plurality of channels extending from a first end proximate to the cathode to a second end proximate to the anode along an axis substantially perpendicular to the electrodes. The first end having a first diameter and the second end having a second diameter. The first diameter is greater than the second diameter.

In some embodiments, the plurality of electrochemical cells is horizontally-connected, vertically-connected or combinations thereof.

In certain embodiments, the pair of electrodes include at least one of about 30 wt % graphite, up to about 50 wt % disordered carbon, up to about 50 wt % PAN based carbon fiber, one or more halogen stable polymers, and a transition metal impurity concentration less than about 100 ppm.

In yet other embodiments, the one or more halogen stable polymers include polyvinylidene fluoride (PVDF), polytetrafluoroethylene (PTFE), high density polyethylene (HDPE), or combinations thereof.

In particular embodiments, the electrolyte includes about 2-5M zinc bromide salt, between about 1M and about 4M potassium chloride, potassium bromide, or combinations thereof, less than about 0.1M sulfuric acid, hydrochloric acid, hydrobromic acid, or combinations thereof, up to about 10 wt % fumed silica, up to about 3M zinc chloride, zinc sulfate, zinc acetate, or combinations thereof, up to about 3M calcium chloride, calcium bromide, calcium sulfate, magnesium chloride, magnesium bromide, magnesium sulfate, aluminum chloride, aluminum bromide, aluminum sulfate, or combinations thereof, less than about 200 ppm bismuth bromide/chloride, lead(II) bromide/chloride, tin bromide/chloride, indium bromide/chloride, silver bromide/chloride, or combinations thereof, less than about 5 wt % organic zinc leveling agents, and less than about 1 wt % ionic surfactant.

In some embodiments, the flow shaping baffle is positioned between the pair electrodes and between about 0.25 cm and about 3 cm from the cathode.

In other embodiments, the pair of electrodes are separated by between about 0.5 cm and about 3 cm.

In certain embodiments, each channel in the plurality of channels has an average width below about 3 cm.

In some embodiments, the plurality of electrochemical cells includes male connections, female connections, or combinations thereof.

In other embodiments, the plurality of electrochemical cells is connected in series, in parallel, or combinations thereof.

In certain embodiments, a separator is disposed between the pair of electrodes.

In particular embodiments, the separator is composed of glass fiber, glass frit, ceramic frit, polypropylene, polyethylene, PVDF, Nafion® or other ion-selective membrane, carbon or graphite, or combinations thereof.

In one embodiment, the separator and the flow shaping baffle are an integrated structure.

In another non limiting aspect of the present disclosure, an electrochemical flow battery system includes a plurality of electrochemical cells. The plurality of electrochemical cells each having a pair of electrodes including an anode and a cathode, and a separator and/or a flow shaping baffle disposed between the pair of electrodes. At least one electrolyte in is communication with the pair of electrodes. A plurality of first enclosures each encloses at least one of the plurality of electrochemical cells. A second enclosure encloses the plurality of first enclosures.

In one embodiment, the plurality of electrochemical cells is a plurality of zinc bromide battery cells.

In some embodiments, the electrochemical flow battery system includes one or more control modules, communication modules, thermal management modules, battery management modules, inverters, or combinations thereof.

In certain embodiments of this aspect, each of the plurality of electrochemical cells includes a flow shaping baffle having a plurality of channels. The channels extend from a first end proximate to the cathode to a second end proximate to the anode along an axis substantially perpendicular to the electrodes. The first end has a first diameter and the second end has a second diameter. The pluralities first diameter is greater than the second diameter.

In some embodiments, the flow shaping baffle in each of the plurality of electrochemical cells is positioned between the pair electrodes and between about 0.25 cm and about 3 cm from the cathode.

In particular embodiments, the flow shaping baffle in each of the plurality of electrochemical cells, has an average width below about 3 cm.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1A depict a battery system according to one embodiment of the present disclosure;

FIG. 1B depicts some of the elements of a battery system according to one embodiment of the present disclosure;

FIGS. 1C-1D depicts several embodiments of an installed battery system according to one embodiment of the present disclosure;

FIGS. 2A-2B depict various battery cell terminal configurations according to one embodiment of the present disclosure;

FIG. 2C depicts several battery cell connection configurations according to one embodiment of the present disclosure;

FIG. 2D depicts various configurations for stacking a plurality of interconnected battery cells within a system enclosure;

FIG. 3 depicts the configuration of an electrochemical cell according to one embodiment of the present disclosure;

FIG. 4A depicts the configuration of an electrochemical cell including a separator material according to one embodiment of the present disclosure;

FIG. 4B depicts the configuration of an electrochemical cell including a shaping baffle according to one embodiment of the present disclosure;

FIG. 4C depicts the configuration of an electrochemical cell including a separator material and shaping baffle according to one embodiment of the present disclosure;

FIG. 4D depicts the configuration of an electrochemical cell including an integrated separator and baffle according to one embodiment of the present disclosure;

FIG. 5 depicts one particular configuration of an electrochemical cell according to an embodiment of the present disclosure; and

FIG. 6 depicts a graph illustrating the Rayleigh number vs. battery cell height at a specific current density.

### DESCRIPTION

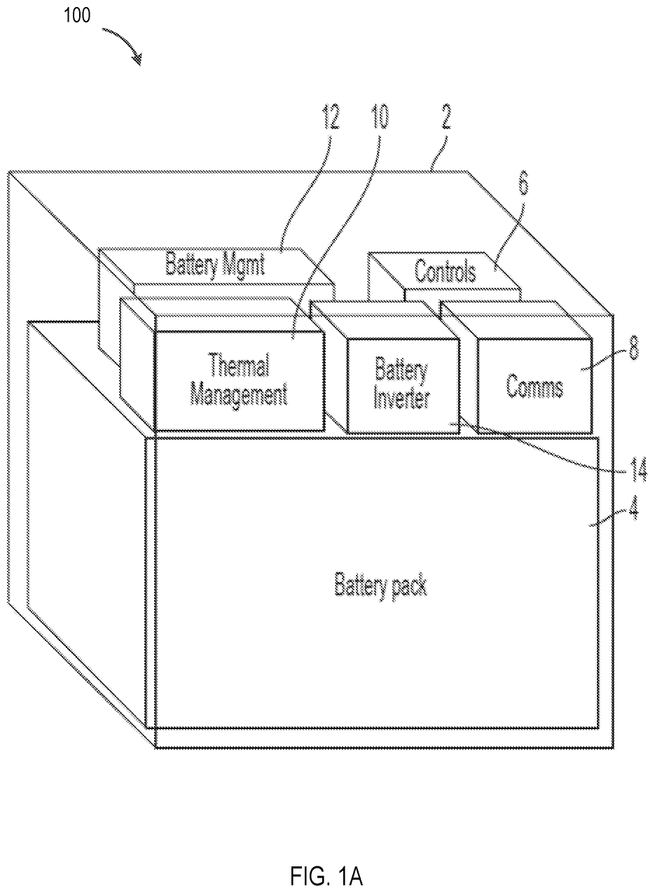

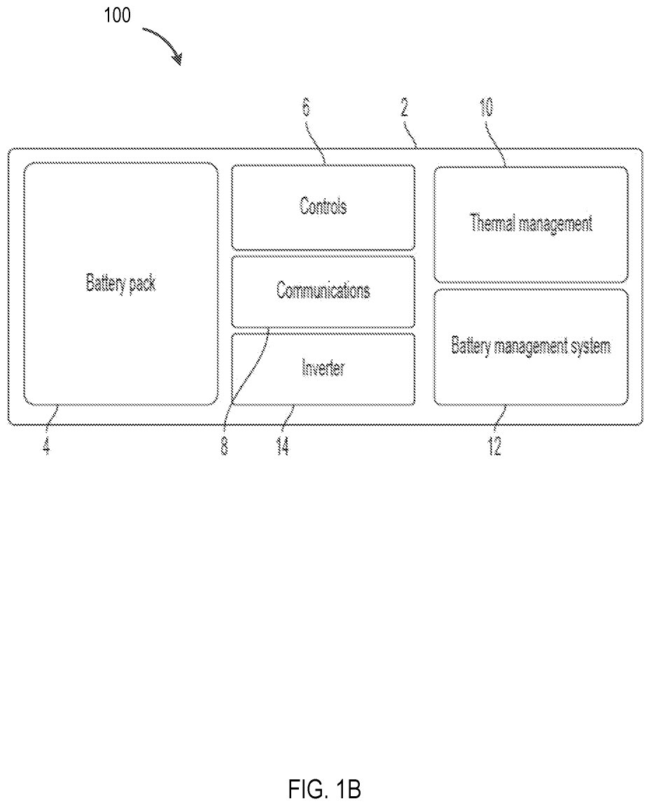

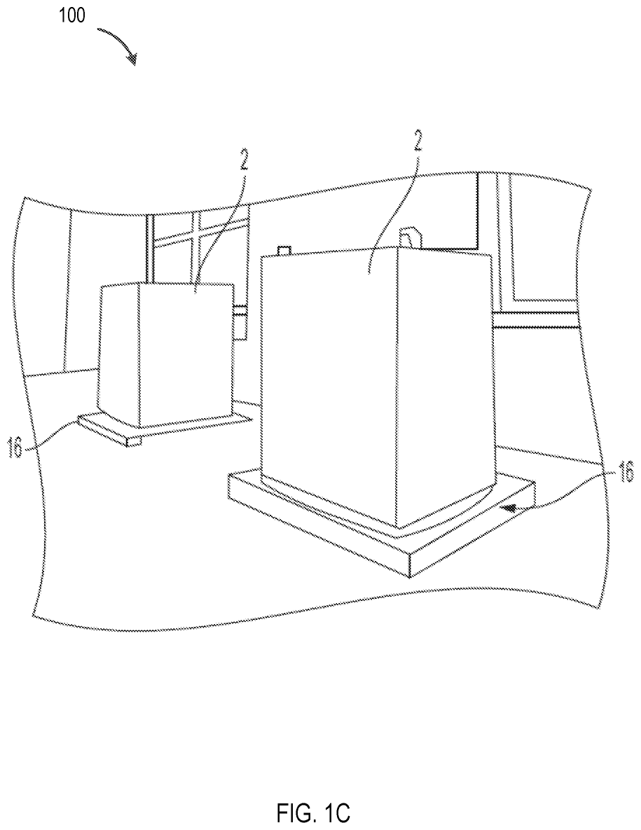

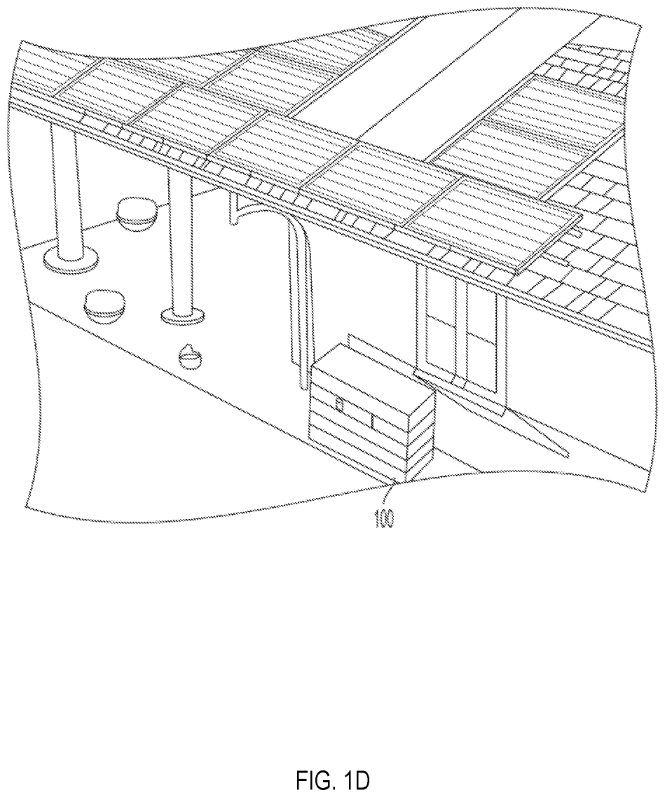

Referring now to FIGS. 1A-1D, some aspects of the present disclosure are directed to an energy storage system. In some embodiments, the energy storage system includes electrochemical flow battery system 100 including a system enclosure 2. The system enclosure 2 includes at least one electrochemical cell or battery 4. The at least one electrochemical cell or battery 4. The battery 4 can include an anode 48, a cathode 46, and at least one separator 50 and/or flow shaping baffle 50A. The battery 4 can include at least one electrolyte 52 in communication with the anode 48 and cathode 46. In some embodiments, the battery 4 can be a zinc-bromide battery.

In some embodiments, the battery system 100 can be configured for use in a horizontal cell format and the system 100 can be pumpless, i.e., the system 100 is pumpless; that is, the system 100 does not use a mechanical pump to circulate the electrolyte 52. The system 100 can include one or more control modules 6, communication modules 8, thermal management modules 10, battery management modules 12, inverters 14, or combinations thereof (See e.g., FIG. 1A).

Referring now to FIG. 1D, in some embodiments, the system 100 is configured for use outdoors. In some embodiments, the system 100 includes a base 16 for stability, e.g., composed of concrete, reinforced material, etc. In some embodiments, one or more systems 100 can be installed and utilized for a given application, e.g., where increased power and/or energy capacity are desired.

As discussed above, in some embodiments, the system 100 can include a plurality of electrochemical cells or batteries 4. The electrochemical cells 4 can include an ion exchange membrane (not shown). In some embodiments, the electrochemical cells can include cell terminals 20. In other embodiments, the system does not include an ion exchange membrane or a pump.

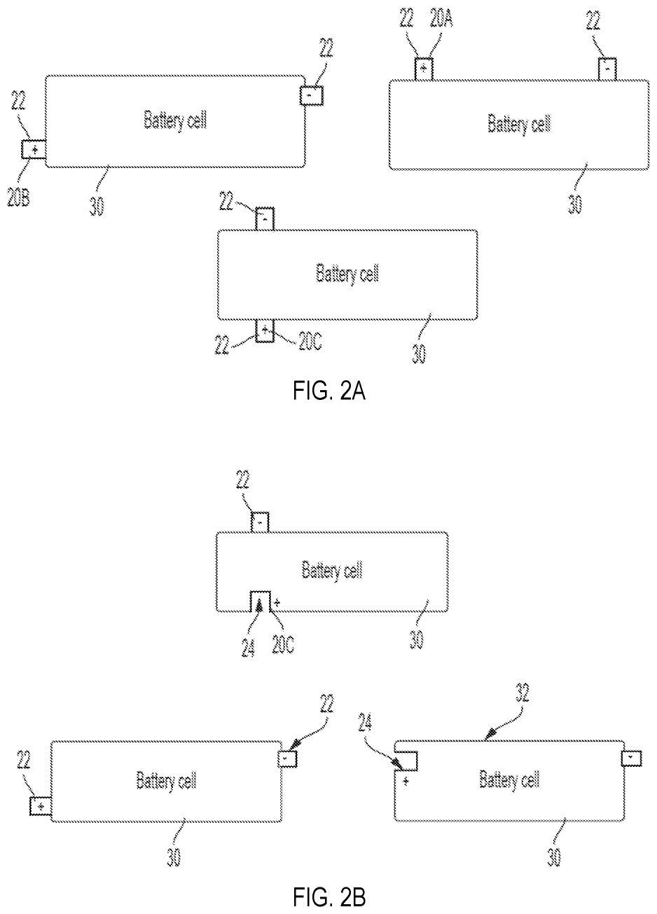

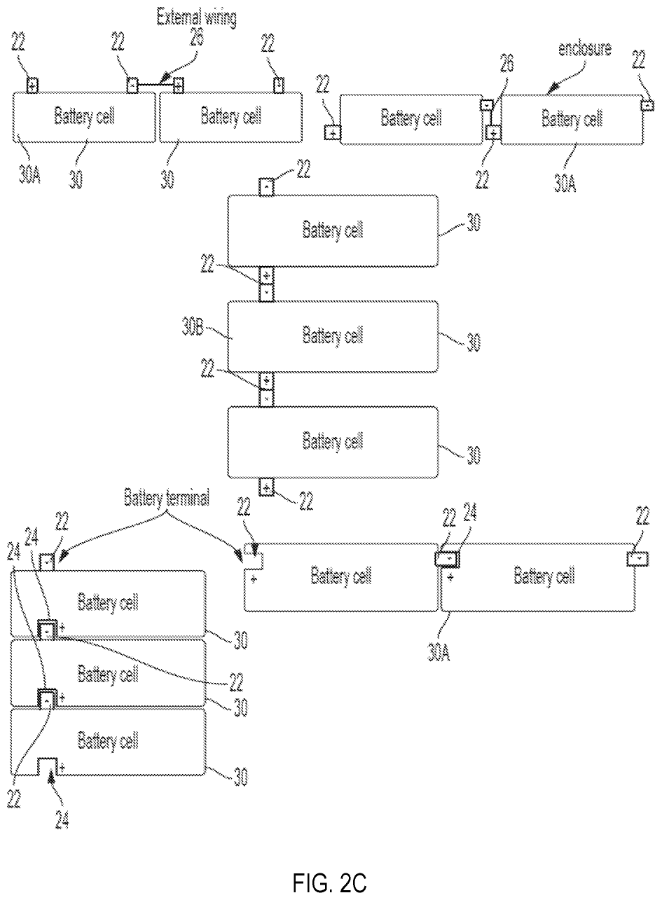

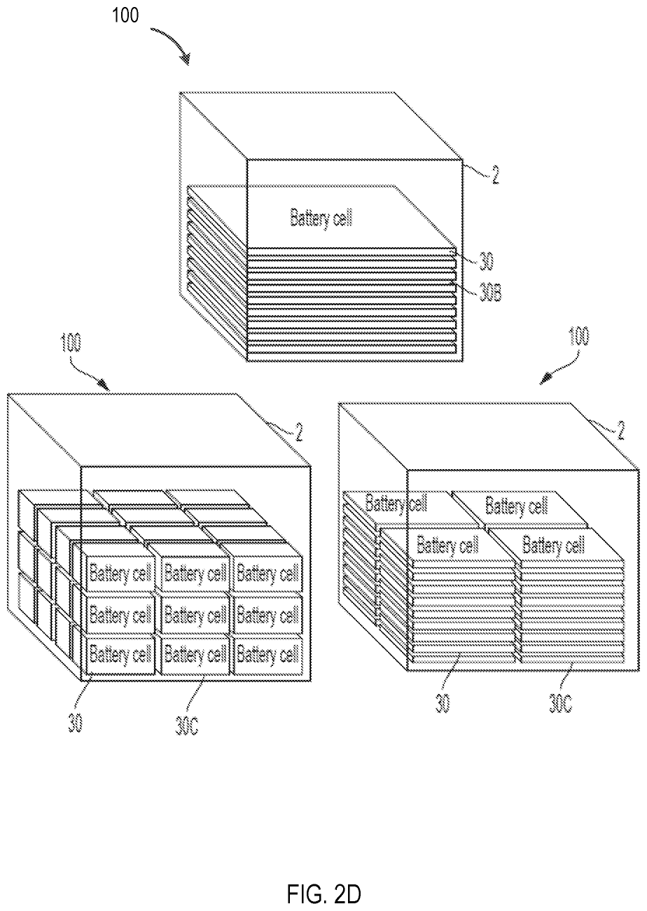

Referring now to FIG. 2A, in some embodiments, cell terminals 20 can be top mounted 20A, side mounted 20B, bottom mounted 20C, or combinations thereof on individual battery cells 30. Referring now to FIG. 2B, in some embodiments, the cell terminals 20 can be male terminals 22, female terminals 24 terminal or combinations thereof. The cell terminals 20 can used to connect or interconnect the battery cells 30 and a plurality of desired configurations as discussed below. In some embodiments, an electrochemical cell or battery 30 includes an enclosure 32 for each battery 30, i.e., a body, shell, etc. In some embodiments, the system 100 includes a plurality of batteries 30 housing within an enclosure 2, i.e., a body, shell, etc.

Referring now to FIGS. 2C-2D, a plurality of electrochemical cells 30 in the system can be connected horizontally 30A, vertically 30B, or combinations thereof 30C. In some embodiments, the plurality of electrochemical cells 30 are connected via wiring 26, the male-female connections 22, 24, or combinations thereof. In some embodiments, the plurality of electrochemical cells 30 are connected in series, in parallel, or combinations thereof.

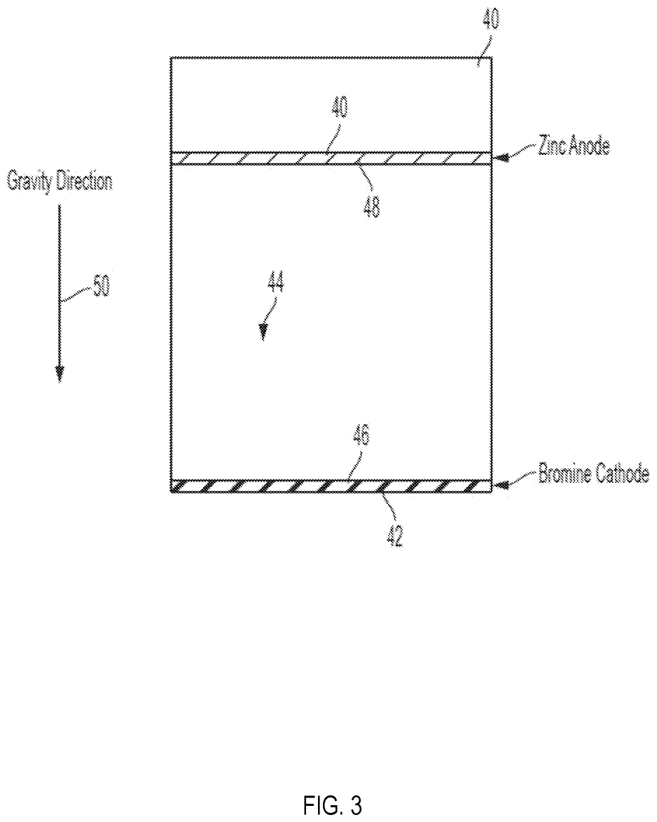

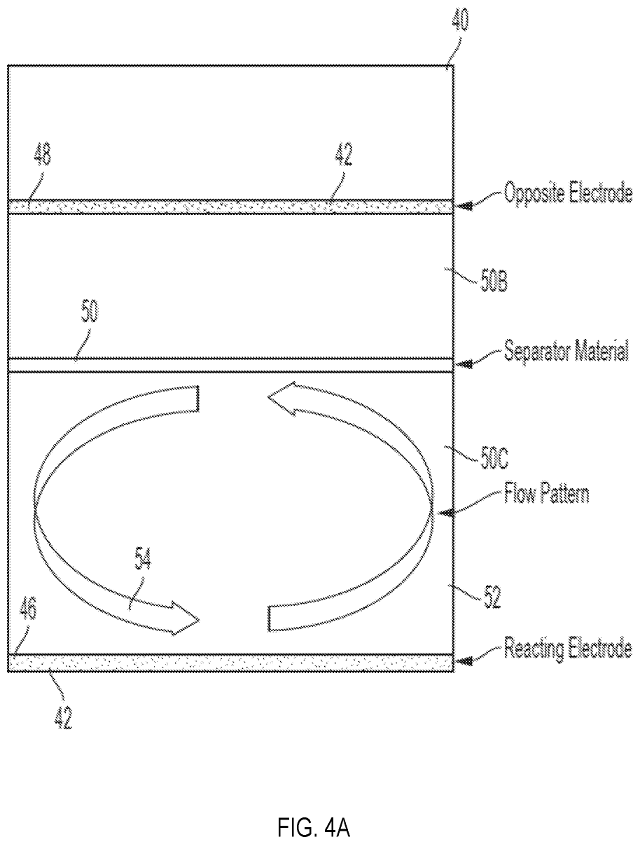

In one non-limiting embodiment, referring to FIG. 3, an electrochemical cell 40 includes a pair of electrodes 42. The pair of electrodes 42 are positioned in a single chamber 44 (electrolyte not shown). In some embodiments, electrodes 42 include at least one anode and at least one cathode. The pair of electrodes can include a zinc anode 48 and a bromine cathode 46. The anode and the cathode 48, 46 can be substantially planar and can extend substantially horizontally. The anode and the cathode 48, 46 can be substantially parallel and substantially perpendicular to the force of gravity 50.

In some embodiments, the anode 48 and the cathode 46 can be arranged in a stacked configuration. In this embodiment, the cathode 46 is positioned below the anode 48. In some embodiments, the anode 48 and the cathode 46 are separated by between about 0.5 cm and about 3 cm. The anode 48 and the cathode 46 can have a thickness of about 1 cm. In some embodiments, the anode 48 and the cathode 46 have a thickness of less than about 1 cm.

Without wishing to be bound by theory, these electrodes 42 can be used as both a reaction surface with an electrolyte 52 (discussed in greater detail below), e.g., for bromine oxidation/reduction, as well as the plating/stripping of metal, e.g., zinc. In some embodiments, the electrodes 42 can be highly dense and non-porous. The electrodes 42 can include a carbon component or a plurality of carbon components. In some embodiments, the electrodes 42 include between about 20 wt % and about 40 wt % graphite, e.g., for improved conductivity. The electrodes 42 can include about 30 wt % graphite.

In some embodiments, the electrodes 42 can include up to between about 40 wt % and about 60 wt % disordered carbon, e.g., to increase surface area and decrease charge transfer resistance. In some embodiments, the electrodes 42 can include up to about 50 wt % disordered carbon. The disordered carbon can include carbon black, activated carbon, or combinations thereof.

In some embodiments, the electrodes 42 can include up to between about 40 wt % and about 60 wt % PAN based carbon fiber, e.g., as a structural component and conductivity enhancing agent. The electrodes 42 can include up to about 50% PAN based carbon fiber.

In some embodiments, the electrodes 42 can include a halogen stable polymer, e.g., a bromine stable polymer. The polymer can include polyvinylidene fluoride (PVDF), polytetrafluoroethylene (PTFE), high density polyethylene (HDPE), or combinations thereof.

In some embodiments, the electrodes 42 can have a transition metal, e.g., iron, having an impurity level of lower than about 200 ppm, about 100 ppm, or about 50 ppm.

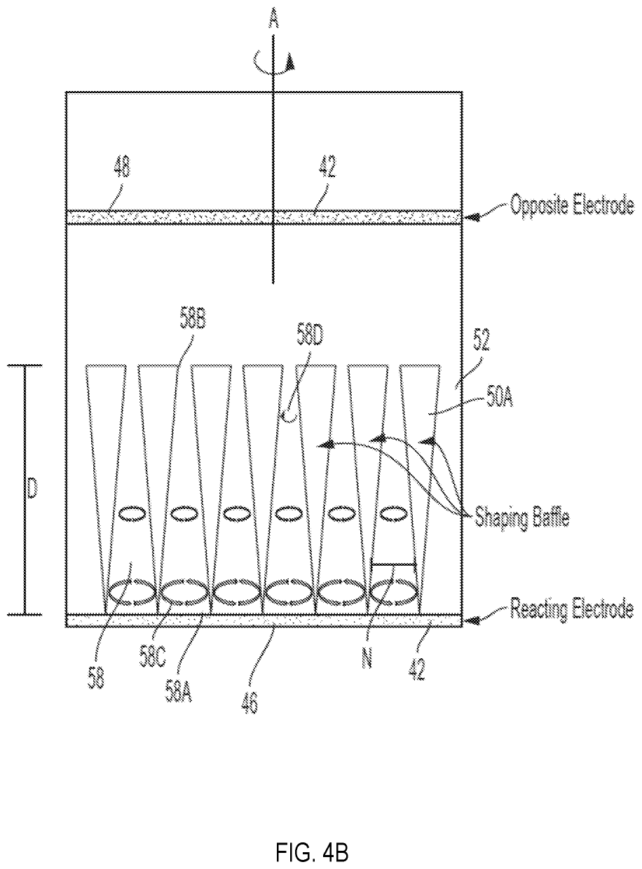

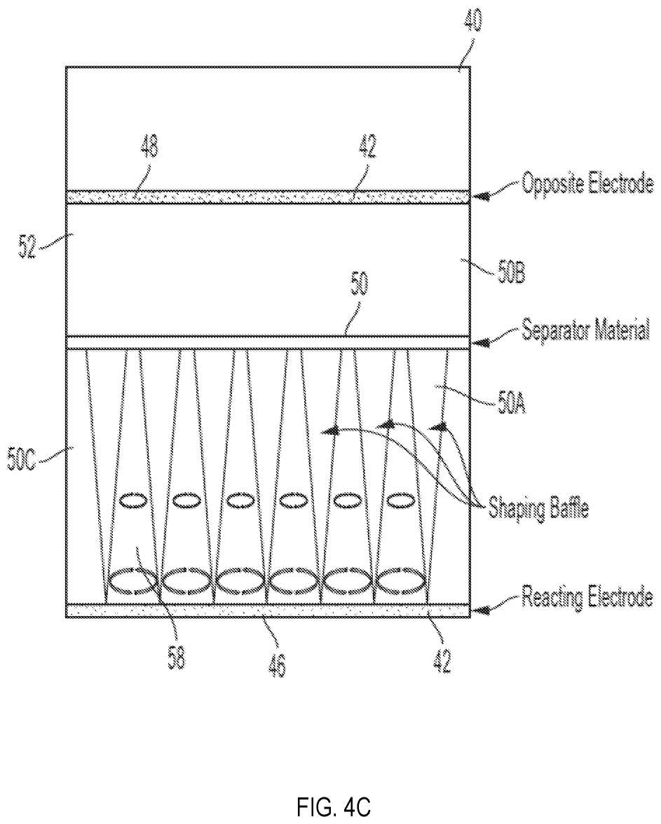

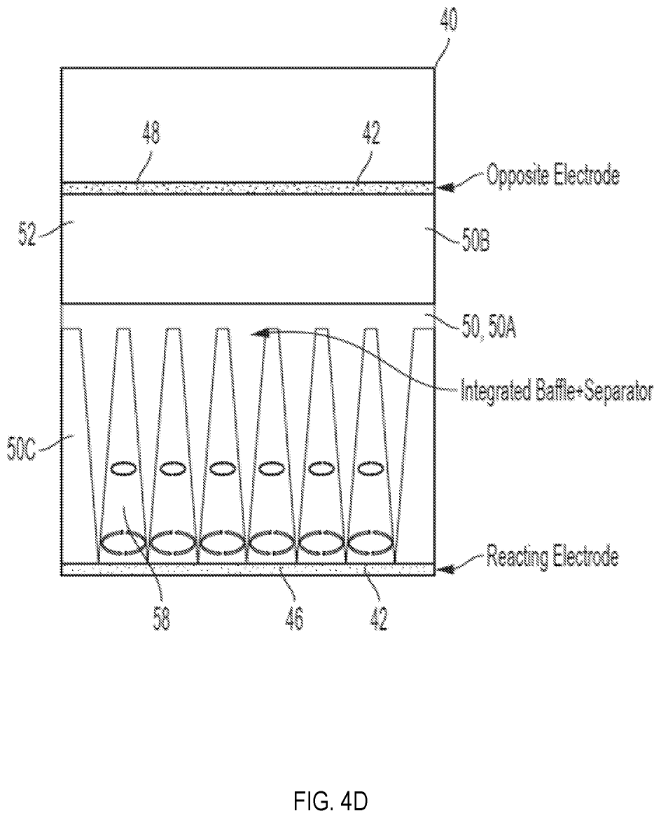

Referring now to FIG. 4A, the system can include a separator 50 positioned between the electrodes 42. The separator 50 can be composed of substantially inert material. In some embodiments, the separator 50 can be electrically non-conductive. In some embodiments, the separator 50 can be substantially solid and impermeable to the electrolyte 52, e.g., bromine.

In some embodiments, the separator 50 can be composed of glass fiber, glass frit, ceramic frit, polypropylene, polyethylene, PVDF, Nafion® or other ion-selective membrane, carbon or graphite, or combinations thereof. In some embodiments, the separator 50 can be porous to allow ion current flow. In some embodiments, flow though the separator 50 is tortuous.

Referring to FIG. 4B, the electrochemical cell 40 can include a flow shaping baffle 50A. In some embodiments, flow shaping baffle 50A is situated between electrodes 42. The flow shaping control baffle 50A can include one or more channels 58. The channels 58 can be straight, angled, curved, or combinations thereof. The channels 58 extend from a first end 58A proximate the cathode 46 to a second end 58B proximate the anode along an axis A substantially perpendicular to the electrodes 42, the first end 58A having a first diameter 58C and the second end 58B having a second diameter 58D, wherein the first diameter 58C is greater than the second 58D diameter.

The cross-sectional area of the channels 58 can be variable, i.e., increases or decreases along a length of the channel 58. The channels 58 can have a higher cross-sectional area near the cathode 46 and a lower cross section area near the anode 48. In some embodiments, the channels 58 have an average width W below about 3 cm, 2 cm, or 1 cm.

The separator 50 and/or the flow shaping baffle 50A can be configured to limit convective flow. In some embodiments, separator 50 and the flow shaping baffle 50A are an integrated structure. The separator 50 and/or the flow shaping baffle 50A can have a thickness and a porosity configured to provide substantially complete convective isolation. The thickness and porosity of the separator 50 and/or the flow shaping baffle 50A depends on the electrolyte properties giving rise to flow. The thickness of the separator 50 and/or the baffle 50A can be between about 1 mm and about 2 cm. The separator 50 and/or the flow shaping baffle 50A can be positioned a predetermined distance D from the cathode 46 and/or the anode 48. The distance D of the separator 50 and/or the flow shaping baffle 50A above the reacting electrode (cathode) 46 is designed to be above the diffusion layer of active material formed during charging. Thus, reactant material formed during charging will be available to the loops on discharge. In some embodiments, the separator 50 and/or the flow shaping baffle 50A is positioned at a distance D between about 0.25 cm and about 3 cm above the reacting electrode 46 (cathode).

Without wishing to be bound by theory, the separator 50 and/or the flow shaping baffle 50A creates separated flow loops in both the upper 50B and lower 50C cell chambers above and below the separator 50 and/or the flow shaping baffle 50A. The separator 50 and/or the flow shaping baffle 50A prevents convective flow (arrows 54 indicating flow loop limited to the lower chamber 50C) from crossing the cell and keeps a flow loop 54 contained to one electrode 46, 48. The separator 50 and/or the flow shaping baffle 50A enables physical separation and pump-free utilization of soluble reaction products generated, e.g., as a cell charges. In standard flow battery designs, an expensive ion exchange membrane is used to prevent the crossover of the active species and a pump is used to actively circulate the electrolyte 52 to ensure full utilization of the reactant. These components are major cost drivers in flow batteries and are not necessary with the novel designs disclosed herein. The designs consistent with the present disclosure take advantage of the natural flow that arises due to density gradients that form as reactions take place at the electrode surface. The separator 50 and/or the flow shaping baffle 50A shapes this natural flow to prevent detrimental crossover reactions and assists in driving reactants towards the proper electrode 48, 46 for the reaction.

In some embodiments, the system includes at least one electrolyte 52 in communication with the anode 48 and the cathode 46. The electrolyte 52 can be water based. The electrolyte 52 can include one or more metal halide salts, e.g., as a primary reaction agent. The concentration of the metal halide salt can be between about 1M and about 6M. In some embodiments, the concentration of the metal halide salt is between about 2M and about 5M. The metal halide salt can include zinc bromide salt.

In some embodiments, the electrolyte 52 can include one or more conductivity enhancing agents. The concentration of conductivity enhancing agent can be between about 0.5M and about 5M. In some embodiments, the concentration of conductivity enhancing agent is between about 1M and about 4M. The conductivity enhancing agent can include a potassium halide compound. In some embodiments, the conductivity enhancing agent includes potassium chloride, potassium bromide, or combinations thereof.

In some embodiments, the electrolyte 52 includes a pH buffering agent. The concentration of the pH buffering agent can be less than about 0.3, 0.2, 0.1, or 0.5M. In some embodiments, the pH buffering agent includes sulfuric acid, hydrochloric acid, hydrobromic acid, or combinations thereof.

The electrolyte 52 can include a thickening agent. In some embodiments, the concentration of thickening agent can be between about 5 wt % and about 20 wt %. In some embodiments, the concentration of thickening agent is about 10 wt %. The thickening agent can include a material having an average particle size of less than about 100 nm, 75 nm, 50 nm, or 25 nm. In some embodiments, the electrolyte 52 includes fumed silica particles as a thickening agent.

The electrolyte 52 can include one or more density gradient modifying agents. The density gradient modifying agents can have a concentration up to about between 2M and about 4M. In some embodiments, the density gradient modifying agents have a concentration up to about 3M. The density gradient modifying agent(s) can include zinc. In some embodiments, the density gradient modifying agent(s) can include zinc chloride, zinc sulfate, zinc acetate, or combinations thereof.

The density gradient modifying agent(s) can include a non-reactive metal halide, metal sulfate, or combinations thereof. In some embodiments, the density gradient modifying agent includes calcium chloride, calcium bromide, calcium sulfate, magnesium chloride, magnesium bromide, magnesium sulfate, aluminum chloride, aluminum bromide, aluminum sulfate, or combinations thereof.

In some embodiments, the electrolyte 52 can include less than about 300 ppm, 200 ppm, or 100 ppm of metal additives. In some embodiments, the metal additives can include transition metal halides, e.g., bromides/chlorides. In some embodiments, the metal additives include bismuth bromide/chloride, lead (II) bromide/chloride, tin bromide/chloride, indium bromide/chloride, silver bromide/chloride, or combinations thereof.

The electrolyte 52 can include one or more leveling agents, e.g., organic zinc leveling agents. In some embodiments, the concentration of leveling agent is less than about 10 wt %, 5 wt %, or 2.5 wt %. The leveling agents can include polyethylene glycol, polyethylene oxide, polyethylene methyl ether (and various other end groups), other glycols, etc., or combinations thereof.

The electrolyte 52 can include one or more surfactants. In some embodiments, the electrolyte 52 includes one or more ionic surfactants. In some embodiments, the concentration of the surfactant is less than about 2 wt %, 1 wt %, or 0.5 wt %. The surfactant can include sodium decyl sulfate, sodium dodecyl sulfate, cetyltrimethylammonium bromide, cetylpyridinium chloride, or combinations thereof.

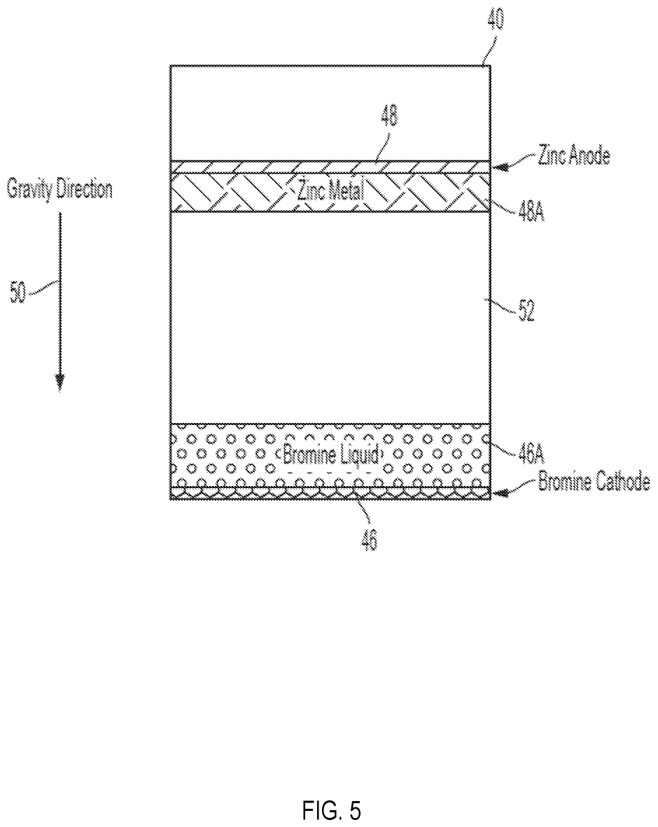

Referring now to FIG. 5, the electrolyte 52 can include components to enhance the magnitude of the density gradient formed during the cathode 46 reaction, e.g., of converting back and forth between the bromine/bromide species. The bromine reaction product will be denser than the solvated zinc bromide reactant. Orienting such that the cathode 46, e.g., bromine electrode, is at the bottom of the cell allows the bromine reaction product 46A to pool uniformly at the cell bottom, keeping it physically separated from the zinc anode 48. In exemplary embodiments, bromine is highly soluble in the electrolyte 52 so it will still diffuse from the cathode 46 surface to the anode 48. A planar electrode 42 at the bromine cathode 46 can ensure that the bromine formation reaction takes place as far away from the zinc anode 48 as possible, where bromine is formed/reacted at the bottom the cell and zinc is plated/stripped at the top 48A. Greater distances between the electrode 48, 46 surfaces allow more time of battery operation before diffusive crossover dominates or reduces system efficiency.

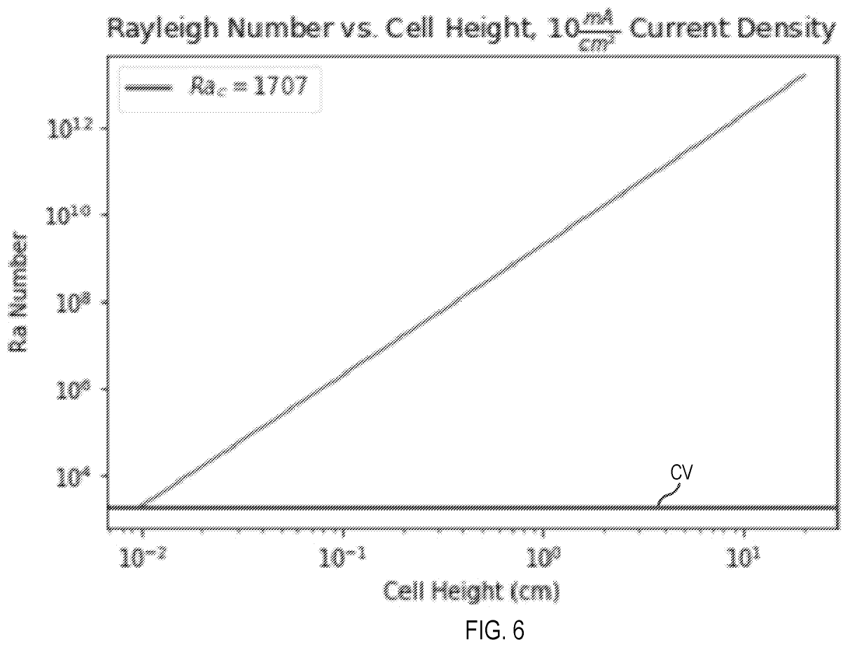

Referring now to FIG. 6, the non-dimensional parameter governing the fluid flow within the system is the electrochemical Rayleigh Number given by:

$$Ra = \frac{{gd}^{3} β Δ c}{μ D}$$

wherein g is the gravitational acceleration, β is change in density from a given change in species concentration, A c is the change in concentration at the electrode surface due to reaction, d is the distance between electrodes in the cell, μ is the dynamic viscosity, and D is the diffusion coefficient of the given species. Systems where this value is larger than the critical value of 1707.76 (CV) will give rise to convective flow and will benefit from the disclosed design. Without wishing to be bound by theory, in the event where a density change is positive, the solution phase reaction and flow control will be positioned at the bottom of the cell (in the lowermost gravity direction). In a system where the density change of reaction is negative, the same design can be used having the flow control and reaction at the top of the cell (in the uppermost gravity direction). In some embodiments, the channels of the separator have an average width dependent on each electrolyte given by the electrolyte's Rayleigh number. The widths are wide enough to allow significant flow near the electrode surface, but thin enough to slow outward diffusion of the active material.

Methods and systems of the present disclosure are advantageous to provide a low cost, long duration zinc-bromine battery. The electrodes exhibit minimal degradation, e.g., over a period of 10-15 years, and are stable against continuous high concentration (3-5M) aqueous, uncomplexed bromine exposure. The electrodes act as both a current collector and reaction surface and have high conductivity (>1S/cm) and low charge transfer resistance to bromine oxidation/reduction (0.05 ohms/cm2).

In other inefficient non-pumped zinc bromide designs with vertically oriented electrodes, the denser bromine reaction product can pool at the bottom of the cell leading to stratification of the cell and bromine crossover to the zinc anode. Designs consistent with embodiments of the present disclosure enable high performance and high energy density in a horizontal cell format and do not require active pumping of the electrolyte, or expensive components typically included in zinc bromide battery system designs such as quaternary ammonium complexing agents, or ion exchange membranes.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. An energy storage system, comprising:
a plurality of electrochemical cells, the electrochemical cells including:
a pair of electrodes including an anode and a cathode;
an electrolyte in communication with the pair of electrodes;
a flow shaping baffle situated between the pair of electrodes, the baffle including a plurality of channels extending from a first end proximate the cathode to a second end proximate the anode along an axis substantially perpendicular to the electrodes, the first end having a first diameter and the second end having a second diameter, wherein the first diameter is greater than the second diameter.

2. The energy storage system according to claim 1, wherein the plurality of electrochemical cells is horizontally-connected, vertically-connected or combinations thereof.

3. The energy storage system according to claim 1, wherein the pair of electrodes include at least one of about 30 wt % graphite, up to about 50 wt % disordered carbon, up to about 50 wt % PAN based carbon fiber, one or more halogen stable polymers, and a transition metal impurity concentration less than about 100 ppm.

4. The energy storage system according to claim 3, wherein the one or more halogen stable polymers include polyvinylidene fluoride (PVDF), polytetrafluoroethylene (PTFE), high density polyethylene (HDPE), or combinations thereof.

5. The energy storage system according to claim 1, wherein the electrolyte includes between about 2M to about 5M zinc bromide salt, between about 1M and about 4M potassium chloride, potassium bromide, or combinations thereof, less than about 0.1M sulfuric acid, hydrochloric acid, hydrobromic acid, or combinations thereof, up to about 10 wt % fumed silica; up to about 3M zinc chloride, zinc sulfate, zinc acetate, or combinations thereof, up to about 3M calcium chloride, calcium bromide, calcium sulfate, magnesium chloride, magnesium bromide, magnesium sulfate, aluminum chloride, aluminum bromide, aluminum sulfate, or combinations thereof, less than about 200 ppm bismuth bromide/chloride, lead(II) bromide/chloride, tin bromide/chloride, indium bromide/chloride, silver bromide/chloride, or combinations thereof, less than about 5 wt % organic zinc leveling agents, and less than about lwt % ionic surfactant.

6. The energy storage system according to claim 1, wherein the flow shaping baffle is positioned between the pair electrodes and between about 0.25 cm and about 3 cm from the cathode.

7. The energy storage system according to claim 1, wherein the pair of electrodes are separated by between about 0.5 cm and about 3 cm.

8. The energy storage system according to claim 1, wherein each channel in the plurality of channels has an average width below about 3 cm.

9. The energy storage system according to claim 1, wherein the plurality of electrochemical cells includes male connections, female connections, or combinations thereof.

10. The energy storage system according to claim 1, wherein the plurality of electrochemical cells is connected in series, in parallel, or combinations thereof.

11. The energy storage system according to claim 1, further including a separator disposed between the pair of electrodes.

12. The energy storage system according to claim 11, wherein the separator is composed of glass fiber, glass frit, ceramic frit, polypropylene, polyethylene, PVDF, Nafion® or other ion-selective membrane, carbon or graphite, or combinations thereof.

13. The energy storage system according to claim 11, wherein the separator and the flow shaping baffle are an integrated structure.

14. An electrochemical flow battery system comprising:
a plurality of electrochemical cells, the plurality of electrochemical cells each having a pair of electrodes including an anode and a cathode, and a separator and/or a flow shaping baffle disposed between the pair of electrodes;
at least one electrolyte in communication with the pair of electrodes;
a plurality of first enclosures each encloses at least one of each of the plurality of electrochemical cells; and
a second enclosure encloses the plurality of first enclosures.

15. The electrochemical flow battery system according to claim 14, wherein the plurality of electrochemical cells is a plurality of zinc bromide battery cells.

16. The electrochemical flow battery system according to claim 14, further including one or more control modules, communication modules, thermal management modules, battery management modules, inverters, or combinations thereof.

17. The electrochemical flow battery system according to claim 14, wherein each of the plurality of electrochemical cells includes a flow shaping baffle having a plurality of channels extending from a first end proximate the cathode to a second end proximate the anode along an axis substantially perpendicular to the electrodes, the first end having a first diameter and the second end having a second diameter, wherein the first diameter is greater than the second diameter.

18. The electrochemical flow battery system according to claim 14, wherein the flow shaping baffle in each of the plurality of electrochemical cells is positioned between the pair electrodes and between about 0.25 cm and about 3 cm from the cathode.

19. The electrochemical flow battery system according to claim 17, wherein each channel in the plurality of channels has an average width below about 3 cm.

20. The electrochemical flow battery system according to claim 14, wherein the system is pumpless.
